(19) United States
(12) Patent Application Publication
(10) Pub. No.: US 2023/0257911 A1
(43) Pub. Date: Aug. 17, 2023

(54) LIQUID-CRYSTAL POLYESTER FIBERS AND METHOD FOR PRODUCING LIQUID-CRYSTAL POLYESTER FIBERS

(71) Applicant: SUMITOMO CHEMICAL COMPANY, LIMITED, Tokyo (JP)

(72) Inventors: Shinji OHTOMO, Tsukuba-shi (JP); Toshihiko NISHIDA, Tokyo (JP)

(21) Appl. No.: 18/009,184

(22) PCT Filed: Jun. 15, 2021
(86) PCT No.: PCT/JP2021/022713

§ 371 Date: Dec. 8, 2022

(30) Foreign Application Priority Data
Jun. 24, 2020 (JP) 2020-108900

(51) Int. Cl. D01F 6/62

(52) U.S. Cl. CPC D01F 6/62

(57) ABSTRACT

Provided is a liquid crystal polyester fiber comprising a liquid crystal polyester, wherein a maximum value of a crystallite size of 20×10⁻¹⁰ m or larger. The maximum value is obtained by D=K·λ/β cos θ (wherein D represents a crystallite size, λ represents a wavelength of the measurement X-ray, β represents a half-value width (radian), θ represents a diffraction angle, and K represents a Scherrer constant (0.9)) based on a diffraction peak on a 110 plane of an X-ray diffraction spectrum measured by a wide angle X-ray diffraction method using X-ray having a wavelength of 1×10⁻¹⁰ m.

### TECHNICAL FIELD

The present invention relates to a liquid crystal polyester fiber and a method for producing a liquid crystal polyester fiber.

The present application claims a priority based on Japanese Patent Application No. 2020-108900, filed on Jun. 24, 2020, and its content is incorporated herein by reference.

### BACKGROUND ART

Liquid crystal polyesters are widely used in various applications since they have excellent low-hygroscopicity, thermal resistance, thin-walled formability, and the like. Utilizing characteristics of the liquid crystal polyester, fibrillation of the liquid crystal polyester has been investigated in recent years.

A liquid crystal polyester fiber comprising a liquid crystal polyester is commonly formed by melting the liquid crystal polyester once, and then elongating the melted liquid crystal polyester through pores with extruding. In this instance, in a melted liquid crystal polyester, as its viscosity becomes lower, a thinner fiber can be obtained and fibrillation can be favorably achieved (Patent Literature 1).

### CITATION LIST

### Patent Literature

Patent Literature 1: Japanese Patent Laid-Open No. 2010-43380

### SUMMARY OF INVENTION

### Problems to be Solved by the Invention

Even conventional liquid crystal polyester fibers have relatively high thermal resistance. Meanwhile, further higher thermal resistance in liquid crystal polyester fibers has been required so that the liquid crystal polyester fibers can be applied for applications such as a handle heater and protecting clothes.

The present invention has been made in view of the above-described circumstances. An object of the present invention is to provide a liquid crystal polyester fiber having further improved thermal resistance and a method for producing the liquid crystal polyester fiber.

### Means to Solve the Problems

To solve the above problem, the present invention adopts the following constitutions.

[1] A liquid crystal polyester fiber comprising a liquid crystal polyester,

wherein a maximum value of a crystallite size determined by the following [Method for Measuring a Crystallite Size] is 120×10⁻¹⁰ m or larger;

### [Method for Measuring a Crystallite Size]

A crystallite size of the liquid crystal polyester fiber is obtained by a Scherrer equation represented by the following equation (is) based on a diffraction peak of a 110 plane of an X-ray diffraction spectrum measured by a wide angle X-ray diffraction method using X-ray having a wavelength of 1×10⁻¹⁰ m,

D=K·λ/β cos θ (1s)

wherein D represents a crystallite size, λ represents a wavelength of the measurement X-ray, β represents a half-value width (radian), θ represents a diffraction angle, and K represents a Scherrer constant (0.9).

[2] The liquid crystal polyester fiber according to [1], wherein the liquid crystal polyester has a repeating unit (u1) represented by the following formula (1), a repeating unit (u2) represented by the following formula (2), and a repeating unit (u3) represented by the following formula (3), and in the repeating units (u1) to (u3), a ratio of a repeating unit having a 2,6-naphthylene group to a total amount of all the repeating units constituting the liquid crystal polyester is 40 mol % or more,

—O—Ar¹—CO— (1)

—CO—Ar²—CO— (2)

—X—Ar³—Y— (3)

wherein Ar¹ represents a phenylene group, a naphthylene group, or a biphenylylene group; Ar² and Ar³ each independently represents a phenylene group, a naphthylene group, or a biphenylylene group; X and Y each independently represents an oxygen atom or an imino group (—NH—); and a hydrogen atom in the group represented by Ar¹, Ar², or Ar³ is each independently optionally substituted by a halogen atom, an alkyl group having 1 to 10 carbon atoms, or an aryl group having 6 to 20 carbon atoms.

[3] The liquid crystal polyester fiber according to [1], wherein the liquid crystal polyester has a repeating unit (u4) represented by the following formula (4), a repeating unit (u5) represented by the following formula (5), and a repeating unit (u6) represented by the following formula (6),

—O—Ar⁴—CO— (4)

—CO—Ar⁵—CO— (5)

—X—Ar⁶—Y— (6)

wherein Ar⁴ represents a phenylene group; Ar⁵ and Ar⁶ each independently represents a phenylene group or a biphenylylene group; X and Y each independently represents an oxygen atom or an imino group (—NH—); and a hydrogen atom in the groups represented by Ar⁴, Ar⁵, and Ar⁶ is each independently optionally substituted by a halogen atom, an alkyl group having 1 to 10 carbon atoms, or an aryl group having 6 to 20 carbon atoms.

[4] A liquid crystal polyester comprising a liquid crystal polyester; the fiber having a melting point of 360° C. or higher.

[5] A method for producing the liquid crystal polyester fiber according to any one of [1] to [4], the method comprising: a fibrillating step of processing a liquid crystal polyester into a fiber shape by a melt-spinning method; and a heat-treating step of heating, at a temperature of 330° C. or higher, a fibric liquid crystal polyester produced in the fibrillating step.

### Advantageous Effect of Invention

According to the present invention, a liquid crystal polyester fiber having further improved thermal resistance and a method for producing the liquid crystal polyester fiber can be provided.

### BRIEF DESCRIPTION OF DRAWING

FIG. 1 is a schematic view illustrating an example of a spinning machine used for a method for producing a liquid crystal polyester fiber of the present embodiment.

### EMBODIMENTS FOR CARRYING OUT THE INVENTION

(Liquid Crystal Polyester Fiber)

<Liquid Crystal Polyester Fiber of First Embodiment>

A liquid crystal polyester fiber of the first embodiment is a fiber comprising a liquid crystal polyester.

The liquid crystal polyester fiber of the present embodiment has a maximum value of a crystallite size determined by [Method for Measuring Crystallite Size], described later, of 120×10⁻¹⁰ m or larger.

In the liquid crystal polyester fiber of the present embodiment, the maximum value of a crystallite size determined by [Method for Measuring Crystallite Size], described later, is 120×10⁻¹⁰ m or larger, preferably 125×10⁻¹⁰ m or larger, and more preferably 135×10⁻¹⁰ m or larger.

The maximum value of the crystallite size is typically 350×10⁻¹⁰ m or smaller, preferably 310×10⁻¹⁰ m or smaller, and more preferably 190×10⁻¹⁰ m or smaller.

When the maximum value of the crystallite size of the liquid crystal polyester fiber of the present embodiment is equal to or larger than the above preferable lower limit, the thermal resistance is further improved by increasing molecular weight and increasing orientation.

Meanwhile, when the maximum value of the crystallite size of the liquid crystal polyester fiber of the present embodiment is equal to or smaller than the above upper limit, the thermal resistance is easily maintained.

The maximum value of the crystallite size of the liquid crystal polyester fiber of the present embodiment is preferably, for example, 120×10⁻¹⁰ m or larger and 350×10⁻¹⁰ m or smaller, more preferably 125×10⁻¹⁰ m or larger and 310×10⁻¹⁰ m or smaller, and further preferably 135×10⁻¹⁰ m or larger and 190×10⁻¹⁰ m or smaller.

[Method for Measuring Crystallite Size]

The crystallite size of the liquid crystal polyester fiber of the present embodiment is obtained by a Scherrer equation represented by the following equation (is) based on a diffraction peak of a 110 plane of an X-ray diffraction spectrum measured by a wide angle X-ray diffraction method using X-ray having a wavelength of 1×10⁻¹⁰ m,

D=K·λ/β cos θ (1s)

wherein D represents a crystallite size, λ represents a wavelength of the measurement X-ray, β represents a half-value width (radian), θ represents a diffraction angle, and K represents a Scherrer constant (0.9).

Determination of a crystallite size by the equation (1) is a conventionally used method (for example, see “X-ray Structure Analysis-Determination of Atomic Arrangement-”, the third edition published on Apr. 30, 2002, written by Yoshio Waseda and Eiichiro Matsubara).

In the present embodiment, the crystallite size is obtained by performing the following steps (1) to (5) using the wide angle X-ray diffraction method, preferably an X-ray scattering method utilizing a beamline (beam size: approximately 1 μm) in a large synchrotron radiation facility (SPring-8).

Step (1): First, a liquid crystal polyester fiber, which is a sample, is continuously irradiated with X-ray having a wavelength of 1×10⁻¹⁰ m in intervals of 1 μm in a diameter direction of the liquid crystal polyester fiber and then an X-ray diffraction measurement is performed.

A starting point and a finishing point, which are end parts of the liquid crystal polyester fiber with the X-ray entering, are defined as points where a diffraction peak of a 110 plane derived from the liquid crystal polyester fiber appears (starting point) and disappears (finishing point), respectively.

Step (2): The diffraction peak of the 110 plane derived from the liquid crystal polyester is determined.

Step (3): A half-value width (0) of the determined diffraction peak of the 110 plane is obtained.

Step (4): A crystallite size is obtained by using the Scherrer equation.

Step (5): Crystallite sizes are calculated in the step (3) and the step (4) on all the data measured from the starting point where the X-ray enters to the finishing point where the X-ray enters, in the liquid crystal polyester fiber.

The “maximum value of the crystallite size of the liquid crystal polyester fiber” in the liquid crystal polyester fiber is determined as a maximum value of the crystallite sizes obtained by the above steps.

A melting point of the liquid crystal polyester fiber of the present embodiment is preferably 360° C. or higher, more preferably 370° C. or higher, and even more preferably 380° C. or higher.

When the melting point is equal to or higher than the above preferable value, the liquid crystal polyester fiber of the present embodiment is easily applied for products requiring further thermal resistance, such as a handle heater and protecting clothes.

An upper limit of the melting point of the liquid crystal polyester fiber of the present embodiment is not particularly limited, and preferably, for example, 450° C. or lower.

In the present description, the melting point of the liquid crystal polyester fiber is defined as a melting point at a position of an endothermic peak on the highest temperature side observed by a differential calorimetry under a heating condition of 10° C./min from a room temperature.

In the liquid crystal polyester fiber of the present embodiment, the maximum value of the crystallite size and the melting point of the liquid crystal polyester fiber can be controlled by, for example, a type and a producing method (specifically, a heat-treatment temperature and the like) of the liquid crystal polyester.

In the control by the type of the liquid crystal polyester, a type of repeating unit constituting the liquid crystal polyester, its ratio, or the like is appropriately selected.

<Liquid Crystal Polyester>

The liquid crystal polyester resin of the present embodiment is not particularly limited as long as it is a polyester resin exhibiting a liquid-crystalline property in a melted state. The liquid crystal polyester resin of the present embodiment may be a liquid crystal polyester amide, a liquid crystal polyester ether, a liquid crystal polyester carbonate, a liquid crystal polyester imide, and the like.

The liquid crystal polyester resin of the present embodiment is preferably a wholly aromatic liquid crystal polyester using only aromatic compounds as raw material monomers.

Typical examples of the liquid crystal polyester resin of the present embodiment include: a resin synthesized by polymerization (polycondensation) of an aromatic hydroxycarboxylic acid, an aromatic dicarboxylic acid, an aromatic diol, and at least one compound selected from the group consisting of an aromatic hydroxyamine and an aromatic diamine; a resin synthesized by polymerization of a plurality of types of aromatic hydroxycarboxylic acid; a resin synthesized by polymerization of an aromatic dicarboxylic acid, an aromatic diol, and at least one compound selected from the group consisting of an aromatic hydroxyamine and an aromatic diamine; and a resin synthesized by polymerization of a polyester, such as polyethylene terephthalate, and an aromatic hydroxycarboxylic acid.

Here, as each of the aromatic hydroxycarboxylic acid, the aromatic dicarboxylic acid, the aromatic diol, the aromatic hydroxyamine, and the aromatic diamine, a polymerizable derivative thereof may be independently used with replacement of a part or all thereof.

Examples of the polymerizable derivative of the compound having a carboxyl group such as the aromatic hydroxycarboxylic acid and the aromatic dicarboxylic acid include: a compound in which the carboxyl group is converted into an alkoxycarbonyl group or an aryloxycarbonyl group (ester); a compound in which the carboxyl group is converted into a haloformyl group (acid halide); and a compound in which the carboxyl group is converted into an acyloxycarbonyl group (acid anhydride).

Examples of the polymerizable derivative of the compound having a hydroxyl group such as the aromatic hydroxycarboxylic acid, the aromatic diol, and the aromatic hydroxyamine include a compound in which the hydroxyl group is acylated to be converted into an acyloxyl group (acylated compound).

Examples of the polymerizable derivative of the compound having an amino group such as the aromatic hydroxyamine and the aromatic diamine include a compound in which the amino group is acylated to be converted into an acylamino group (acylated compound).

In the liquid crystal polyester used as a raw material of the liquid crystal polyester fiber, a flow starting temperature is, for example, 280° C. or higher, preferably 280° C. or higher and 400° C. or lower, and more preferably 280° C. or higher and 360° C. or lower. As a flow starting temperature becomes higher, the thermal resistance, strength, and rigidity is easily improved. A flow starting temperature exceedingly high, however, a melting temperature and a melting viscosity tend to rise and fibrillation tends to be difficult.

The flow starting temperature, which is also referred to as a flow temperature or a flowing temperature, is a temperature at which the liquid crystal polyester exhibits a melting viscosity of 4800 Pa·s (48000 poises) when extruded through a nozzle having an inner diameter of 1 mm and a length of 10 mm under a load of 9.8 MPa (100 kg/cm²) with heating at a rate of 4° C./min using a capillary rheometer. The flow starting temperature is a guide of a molecular weight of the liquid crystal polyester (see “Liquid-Crystal Polymer—Synthesis, Molding, Application—”, edited by Naoyuki Koide, CMC Publishing Co., Ltd., Jun. 5, 1987, p. 95).

Among the above, the liquid crystal polyester resin of the present embodiment is preferably a liquid crystal polyester resin A or a liquid crystal polyester resin B, which are described later. From a viewpoint of further improvement of the strength of the obtained liquid crystal polyester fiber, the resin A is preferable. From a viewpoint of further improvement of elasticity of the obtained liquid crystal polyester, the resin B is preferable.

<<Liquid Crystal Polyester A>>

The liquid crystal polyester A is a resin having a repeating unit (u1) represented by the following formula (1) (hereinafter, also referred to as “the repeating unit (u1)”), a repeating unit (u2) represented by the following formula (2) (hereinafter, also referred to as “the repeating unit (u2)”), and a repeating unit (u3) represented by the following formula (3) (hereinafter, also referred to as “the repeating unit (u3)”).

In the repeating units (u1) to (u3), a ratio of a repeating unit having a 2,6-naphthylene group to a total amount of all the repeating units constituting the liquid crystal polyester is 40 mol % or more,

—O—Ar¹—CO— (1)

—CO—Ar²—CO— (2)

—X—Ar³—Y— (3)

wherein Ar¹ represents a phenylene group, a naphthylene group, or a biphenylylene group; Ar² and Ar³ each independently represents a phenylene group, a naphthylene group, or a biphenylylene group; X and Y each independently represents an oxygen atom or an imino group (—NH—); and a hydrogen atom in the group represented by Ar¹, Ar², or Ar³ is each independently optionally substituted by a halogen atom, an alkyl group having 1 to 10 carbon atoms, or an aryl group having 6 to 20 carbon atoms.

—Repeating Unit (u1)

The repeating unit (u1) is a repeating unit derived from a predetermined aromatic hydroxycarboxylic acid.

The term “derived” in the present description means that changes of chemical structures for polymerization of a raw material monomer occur, but no other changes of structures occur.

In the formula (1), Ar¹ represents a phenylene group, a naphthylene group, or a biphenylylene group, and a hydrogen atom in the phenylene group, the naphthylene group, and the biphenylylene group is optionally substituted by a halogen atom, an alkyl group having 1 to 10 carbon atoms, or an aryl group having 6 to 20 carbon atoms.

Examples of the halogen atom include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group.

Examples of the aryl group include a phenyl group, an o-tolyl group, a m-tolyl group, a p-tolyl group, a 1-naphthyl group, and a 2-naphthyl group.

Among the above, the repeating unit (u1) is preferably a repeating unit in which Ar¹ represents a p-phenylene group (a repeating unit derived from p-hydroxybenzoic acid) and a repeating unit in which Ar¹ represents a 2,6-naphthylene group (a repeating unit derived from 6-hydroxy-2-naphthoic acid), and more preferably a repeating unit in which Ar¹ represents a 2,6-naphthylene group (a repeating unit derived from 6-hydroxy-2-naphthoic acid).

—Repeating Unit (u2)

The repeating unit (u2) is a repeating unit derived from a predetermined aromatic dicarboxylic acid.

Ar² represents a phenylene group, a naphthylene group, or a biphenylylene group, and a hydrogen atom in the phenylene group, the naphthylene group, and the biphenylylene group is optionally substituted by a halogen atom, an alkyl group having 1 to 10 carbon atoms, or an aryl group having 6 to 20 carbon atoms. Examples of the halogen atom, the alkyl group having 1 to 10 carbon atoms, and the aryl group having 6 to 20 carbon atoms are same as the halogen atom, the alkyl group having 1 to 10 carbon atoms, and the aryl group having 6 to 20 carbon atoms by which the hydrogen atom in the group represented by Ar¹ is optionally substituted.

Among the above, the repeating unit (u2) is preferably a repeating unit in which Ar² represents a p-phenylene group (a repeating unit derived from terephthalic acid), a repeating unit in which Ar² represents a m-phenylene group (a repeating unit derived from isophthalic acid), a repeating unit in which Ar² represents a 2,6-naphthylene group (a repeating unit derived from 2,6-naphthalenedicarboxylic acid), and a repeating unit in which Ar² represents a diphenyl ether-4,4′-diyl group (a repeating unit derived from diphenyl ether-4,4′-dicarboxylic acid), and more preferably a repeating unit in which Ar² represents a p-phenylene group (a repeating unit derived from terephthalic acid) and a repeating unit in which Ar² represents a 2,6-naphthylene group (a repeating unit derived from 2,6-naphthalenedicarboxylic acid).

—Repeating Unit (u3)

The repeating unit (u3) is a repeating unit derived from a predetermined aromatic diol, aromatic hydroxylamine, or aromatic diamine.

Ar³ represents a phenylene group, a naphthylene group, or a biphenylylene group, and a hydrogen atom in the phenylene group, the naphthylene group, and the biphenylylene group is optionally substituted by a halogen atom, an alkyl group having 1 to 10 carbon atoms, or an aryl group having 6 to 20 carbon atoms. Examples of the halogen atom, the alkyl group having 1 to 10 carbon atoms, and the aryl group having 6 to 20 carbon atoms are same as the halogen atom, the alkyl group having 1 to 10 carbon atoms, and the aryl group having 6 to 20 carbon atoms by which the hydrogen atom in the group represented by Ar¹ is optionally substituted.

X and Y each independently represents an oxygen atom or an imino group (—NH—), and the both are preferably oxygen atoms.

The repeating unit (u3) is preferably a repeating unit in which Ar³ represents a p-phenylene group (a repeating unit derived from hydroquinone, p-aminophenol, or p-phenylenediamine) and a repeating unit in which Ar³ represents a 4,4′-biphenylylene group (a repeating unit derived from 4,4′-dihydroxybiphenyl, 4-amino-4′-hydroxybiphenyl, or 4,4′-diaminobiphenyl), and more preferably a repeating unit in which Ar³ represents a p-phenylene group and X and Y represent oxygen atoms (a repeating unit derived from hydroquinone).

In the liquid crystal polyester A of the present embodiment, in the repeating units (u1) to (u3), a ratio of a repeating unit having a 2,6-naphthylene group to a total amount of all the repeating units constituting the liquid crystal polyester is 40 mol % or more, preferably 65 mol % or more, more preferably 68 mol % or more, and further preferably 70% or more.

Meanwhile, the ratio of the repeating unit having a 2,6-naphthylene group to a total amount of all the repeating units constituting the liquid crystal polyester is preferably 85 mol % or less, more preferably 82 mol % or less, and further preferably 80 mol % or less.

When the ratio of the repeating unit having a 2,6-naphthylene group in the liquid crystal polyester A is within the above preferable range, the strength and electrical characteristics (low dielectric dissipation factor) are further improved.

In the liquid crystal polyester A of the present embodiment, the ratio of a repeating unit having a 2,6-naphthylene group to a total amount of all the repeating units constituting the liquid crystal polyester is preferably, for example, 40 mol % or more and 85 mol % or less, more preferably 65 mol % or more and 82 mol % or less, further preferably 68 mol % or more and 80 mol % or less, and particularly preferably 70% or more and 80 mol % or less.

In the liquid crystal polyester A of the present embodiment, a content of the repeating unit (u1) is preferably 30 mol % or more, more preferably 40 mol % or more, and further preferably 45% or more, relative to the total amount of all the repeating units.

Meanwhile, the content of the repeating unit (u1) is preferably 80 mol % or less, more preferably 70 mol % or less, and further preferably 65% or less, relative to the total amount of all the repeating units.

For example, the content of the repeating unit (u1) in the liquid crystal polyester A is preferably 30 mol % or more and 80 mol % or less, more preferably 40 mol % or more and 70 mol % or less, and further preferably 45% or more and 65% or less.

In the liquid crystal polyester A of the present embodiment, a content of the repeating unit (u2) is preferably 10 mol % or more, more preferably 15 mol % or more, and further preferably 17.5% or more, relative to the total amount of all the repeating units.

Meanwhile, the content of the repeating unit (u2) is preferably 35 mol % or less, more preferably 30 mol % or less, and further preferably 27.5% or less, relative to the total amount of all the repeating units.

For example, the content of the repeating unit (u2) in the liquid crystal polyester A is preferably 10 mol % or more and 35 mol % or less, more preferably 15 mol % or more and 30 mol % or less, and further preferably 17.5% or more and 27.5% or less.

In the liquid crystal polyester A of the present embodiment, a content of the repeating unit (u3) is preferably 10 mol % or more, more preferably 15 mol % or more, and further preferably 17.5% or more, relative to the total amount of all the repeating units.

Meanwhile, the content of the repeating unit (u3) is preferably 35 mol % or less, more preferably 30 mol % or less, and further preferably 27.5% or less, relative to the total amount of all the repeating units.

For example, the content of the repeating unit (u3) in the liquid crystal polyester A is preferably 10 mol % or more and 35 mol % or less, more preferably 15 mol % or more and 30 mol % or less, and further preferably 17.5% or more and 27.5% or less.

Such a liquid crystal polyester having the predetermined repeating unit composition has excellent balance between the thermal resistance and fibrillation.

As a content of the repeating unit (u1) becomes higher, the melt flowability, thermal resistance, strength, and rigidity are easily improved. The content is exceedingly high, however, the melting temperature and melting viscosity tend to be high and the temperature required for the fibrillation tends to be high.

The content of the repeating unit (u2) and the content of the repeating unit (u3) in the liquid crystal polyester A are preferably substantially same. A ratio between the content of the repeating unit (u2) and the content of the repeating unit (u3), represented by [content of repeating unit (u2)]/[content of repeating unit (u3)] (mol/mol), is, for example, 0.9/1 to 1/0.9, preferably 0.95/1 to 1/0.95, and more preferably 0.98/1 to 1/0.98.

The liquid crystal polyester A may have independently two or more of each of the repeating units (u1) to (u3). Although the liquid crystal polyester A may have a repeating unit other than the repeating units (u1) to (u3), a content thereof is, for example, 10 mol % or less, and preferably 5 mol % or less, relative to the total amount of all the repeating units.

Specific examples of the liquid crystal polyester A having high thermal resistance include a resin:

(i) having the repeating unit (u1) in which Ar¹ represents a 2,6-naphthylene group (that is, a repeating unit derived from 6-hydroxy-2-naphthoic acid) at preferably 40 mol % or more and 70 mol % or less, more preferably 45 mol % or more and 65 mol % or less, and further preferably 50 mol % or more and 60 mol % or less, relative to the total amount of all the repeating units;

(ii) having the repeating unit (u2) in which Ar² represents a 2,6-naphthylene group (that is, a repeating unit derived from 2,6-naphthalenedicarboxylic acid) at preferably 10 mol % or more and 30 mol % or less, more preferably 12.5 mol % or more and 27.5 mol % or less, and further preferably 15 mol % or more and 25 mol % or less;

(iii) having the repeating unit (u2) in which Ar² represents a 1,4-phenylene group (that is, a repeating unit derived from terephthalic acid) at preferably 1 mol % or more and 15 mol % or less, more preferably 2 mol % or more and 10 mol % or less, and further preferably 3 mol % or more and 7 mol % or less; and (iv) having the repeating unit (u3) in which Ar³ represents a 1,4-phenylene group (that is, a repeating unit derived from hydroquinone) at preferably 12.5 mol % or more and 30 mol % or less, more preferably 17.5 mol % or more and 30 mol % or less, and further preferably 20 mol % or more and 25 mol % or less. In this resin, the total amount of the repeating units (u1) to (u3) does not exceed 100 mol %.

<<Liquid Crystal Polyester B>>

The liquid crystal polyester B is a resin having a repeating unit (u4) represented by the following formula (4) (hereinafter, also referred to as “the repeating unit (u4)”), a repeating unit (u5) represented by the following formula (5) (hereinafter, also referred to as “the repeating unit (u5)”), and a repeating unit (u6) represented by the following formula (6) (hereinafter, also referred to as “the repeating unit (u6)”),

—O—Ar⁴—CO— (4)

—CO—Ar⁵—CO— (5)

—X—Ar⁶—Y— (6)

wherein Ar⁴ represents a phenylene group; Ar⁵ and Ar⁶ each independently represents a phenylene group or a biphenylylene group; X and Y each independently represents an oxygen atom or an imino group (—NH—); and a hydrogen atom in the groups represented by Ar⁴, Ar⁵, and Ar⁶ is each independently optionally substituted by a halogen atom, an alkyl group having 1 to 10 carbon atoms, or an aryl group having 6 to 20 carbon atoms.

—Repeating Unit (u4)

The repeating unit (u4) is a repeating unit derived from a monohydroxybenzoic acid.

In the formula (4), Ar⁴ represents a phenylene group, and a hydrogen atom in the phenylene group is optionally substituted by a halogen atom, an alkyl group having 1 to 10 carbon atoms, or an aryl group having 6 to 20 carbon atoms.

Examples of the halogen atom include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group.

Examples of the aryl group include a phenyl group, an o-tolyl group, a m-tolyl group, a p-tolyl group, a 1-naphthyl group, and a 2-naphthyl group.

Among the above, the repeating unit (u4) is preferably a repeating unit in which Ar⁴ represents a p-phenylene group (a repeating unit derived from p-hydroxybenzoic acid).

—Repeating Unit (u5)

The repeating unit (u5) is a repeating unit derived from a predetermined aromatic dicarboxylic acid.

Ar⁵ represents a phenylene group or a biphenylylene group, and a hydrogen atom in the phenylene group and the biphenylylene group is optionally substituted by a halogen atom, an alkyl group having 1 to 10 carbon atoms, or an aryl group having 6 to 20 carbon atoms. Examples of the halogen atom, the alkyl group having 1 to 10 carbon atoms, and the aryl group having 6 to 20 carbon atoms are same as the halogen atom, the alkyl group having 1 to 10 carbon atoms, and the aryl group having 6 to 20 carbon atoms by which the hydrogen atom in the group represented by Ar⁴ is optionally substituted.

Among the above, the repeating unit (u5) is preferably a repeating unit in which Ar⁵ represents a p-phenylene group (a repeating unit derived from terephthalic acid), a repeating unit in which Ar⁵ represents a m-phenylene group (a repeating unit derived from isophthalic acid), and a repeating unit in which Ar⁵ represents a diphenyl ether-4,4′-diyl group (a repeating unit derived from diphenyl ether-4,4′-dicarboxylic acid), and more preferably a repeating unit in which Ar⁵ represents a p-phenylene group (a repeating unit derived from terephthalic acid) and a repeating unit in which Ar⁵ represents a m-phenylene group (a repeating unit derived from isophthalic acid).

—Repeating Unit (u6)

The repeating unit (u6) is a repeating unit derived from a predetermined aromatic diol, aromatic hydroxylamine, or aromatic diamine.

Ar⁶ represents a phenylene group or a biphenylylene group, and a hydrogen atom in the phenylene group and the biphenylylene group is optionally substituted by a halogen atom, an alkyl group having 1 to 10 carbon atoms, or an aryl group having 6 to 20 carbon atoms. Examples of the halogen atom, the alkyl group having 1 to 10 carbon atoms, and the aryl group having 6 to 20 carbon atoms are same as the halogen atom, the alkyl group having 1 to 10 carbon atoms, and the aryl group having 6 to 20 carbon atoms by which the hydrogen atom in the group represented by Ar⁴ is optionally substituted.

X and Y each independently represents an oxygen atom or an imino group (—NH—), and the both are preferably oxygen atoms.

Among the above, the repeating unit (u6) is preferably a repeating unit in which Ar⁶ represents a p-phenylene group (a repeating unit derived from hydroquinone, p-aminophenol, or p-phenylenediamine) and a repeating unit in which Ar³ represents a 4,4′-biphenylylene group (a repeating unit derived from 4,4′-dihydroxybiphenyl, 4-amino-4′-hydroxybiphenyl, or 4,4′-diaminobiphenyl), and more preferably a repeating unit in which Ar⁶ represents a 4,4′-biphenylylene group and X and Y represent oxygen atoms (a repeating unit derived from 4,4′-dihydroxybiphenyl).

A content of the repeating unit (u4) is preferably 30 mol % or more, more preferably 40 mol % or more, and further preferably 50% or more, relative to the total amount of all the repeating units.

Meanwhile, the content of the repeating unit (u4) is preferably 80 mol % or less, more preferably 70 mol % or less, and further preferably 65% or less, relative to the total amount of all the repeating units.

For example, the content of the repeating unit (u4) in the liquid crystal polyester B is preferably 30 mol % or more and 80 mol % or less, more preferably 40 mol % or more and 70 mol % or less, and further preferably 50% or more and 65% or less.

A content of the repeating unit (u5) is preferably 7 mol % or more, more preferably 10 mol % or more, and further preferably 15% or more, relative to the total amount of all the repeating units.

Meanwhile, the content of the repeating unit (u5) is preferably 35 mol % or less, more preferably 30 mol % or less, and further preferably 25% or less, relative to the total amount of all the repeating units.

For example, the content of the repeating unit (u5) in the liquid crystal polyester B is preferably 7 mol % or more and 35 mol % or less, more preferably 10 mol % or more and 30 mol % or less, and further preferably 15% or more and 25% or less.

A content of the repeating unit (u6) is preferably 7 mol % or more, more preferably 10 mol % or more, and further preferably 15% or more, relative to the total amount of all the repeating units.

Meanwhile, the content of the repeating unit (u6) is preferably 35 mol % or less, more preferably 30 mol % or less, and further preferably 25% or less, relative to the total amount of all the repeating units.

For example, the content of the repeating unit (u6) in the liquid crystal polyester B is preferably 7 mol % or more and 35 mol % or less, more preferably 10 mol % or more and 30 mol % or less, and further preferably 15% or more and 25% or less.

Such a liquid crystal polyester having the predetermined repeating unit composition has excellent balance between the thermal resistance and fibrillation. As a content of the repeating unit (u4) becomes higher, the melt flowability, thermal resistance, strength, and rigidity are easily improved. The content is exceedingly high, however, the melting temperature and melting viscosity tend to be high and the temperature required for the fibrillation tends to be high.

The content of the repeating unit (u5) and the content of the repeating unit (u6) in the liquid crystal polyester B are preferably substantially same. A ratio between the content of the repeating unit (u5) and the content of the repeating unit (u6), represented by [content of repeating unit (u5)]/(content of repeating unit (u6)] (mol/mol), is, for example, 0.9/1 to 1/0.9, preferably 0.95/1 to 1/0.95, and more preferably 0.98/1 to 1/0.98.

The liquid crystal polyester B may have independently two or more of each of the repeating units (u4) to (u6). Although the liquid crystal polyester A may have a repeating unit other than the repeating units (u4) to (u6), a content thereof is, for example, 10 mol % or less, and preferably 5 mol % or less, relative to the total amount of all the repeating units.

Specific examples of the liquid crystal polyester B having high thermal resistance include a resin:

(i) having the repeating unit (u4) in which Ar⁴ represents a p-phenylene group (that is, a repeating unit derived from p-hydroxybenzoic acid) at preferably 40 mol % or more and 80 mol % or less, more preferably 45 mol % or more and 75 mol % or less, and further preferably 50 mol % or more and 70 mol % or less, relative to the total amount of all the repeating units;

(ii) having the repeating unit (u5) in which Ar⁵ represents a p-phenylene group (that is, a repeating unit derived from terephthalic acid) at preferably 1 mol % or more and 30 mol % or less, more preferably 5 mol % or more and 25 mol % or less, and further preferably 10 mol % or more and 20 mol % or less;

(iii) having the repeating unit (u5) in which Ar⁵ represents a m-phenylene group (that is, a repeating unit derived from isophthalic acid) at preferably 1 mol % or more and 15 mol % or less, more preferably 2 mol % or more and 10 mol % or less, and further preferably 3 mol % or more and 7 mol % or less; and

(iv) having the repeating unit (u6) in which Ar⁶ represents a 4,4′-biphenylylene group and X and Y represent oxygen atoms (that is, a repeating unit derived from 4,4′-dihydroxybiphenyl) at preferably 5 mol % or more and 35 mol % or less, more preferably 10 mol % or more and 30 mol % or less, and further preferably 15 mol % or more and 25 mol % or less. In this resin, the total amount of the repeating units (u4) to (u6) does not exceed 100 mol %.

The liquid crystal polyester resin of the present embodiment is preferably manufactured by melt-polymerizing raw material monomers corresponding to the repeating units constituting the resin, followed by solid-phase polymerizing the obtained polymer. According to this method, the liquid crystal polyester resin having a higher molecular weight, high thermal resistance, strength, and rigidity, can be manufactured with good handleability.

The melt polymerization may be performed in the presence of a catalyst. Examples of this catalyst include: metal compounds such as magnesium acetate, stannous acetate, tetrabutyl titanate, lead acetate, sodium acetate, potassium acetate, and antimony trioxide; and nitrogen-containing heterocyclic compounds such as 4-(dimethylamino)pyridine and 1-methylimidazole. The nitrogen-containing heterocyclic compound is preferably used.

The liquid crystal polyester resin of the present embodiment is preferably formed into a pellet shape after melt-kneaded by using an extruder.

A preferably used extruder is an extruder having a cylinder, one or more screws disposed in the cylinder, and one or more feeding ports provided on the cylinder. Furthermore, the extruder more preferably has one or more bent parts provided on the cylinder. On a downstream side of the feeding port (on each downstream side of each feeding port when a plurality of feeding ports is provided), an extruder having a kneading part is preferably used. Here, the kneading part is referred to as a part provided on a part of the screw and effectively performs the melt kneading. Examples of the kneading part include a kneading disk (forward kneading disk, neutral kneading disk, and backward kneading disk) and a mixing screw.

In the extruder, a decompression apparatus is preferably connected to one or more parts having the bent part. During the melt kneading of the liquid crystal polyester, degassing inside the cylinder of the extruder using the decompression apparatus can remove a remained low molecular-weight component from the liquid crystal polyester.

The liquid crystal polyester fiber of the present embodiment may comprise optional components other than the above described liquid crystal polyester without impairing the effect of the present invention. Examples of the optional components include a light resisting agent, carbon black, titanium oxide, a colorant (a pigment and a dye), an antistat, and an antioxidant.

A content of the liquid crystal polyester in the liquid crystal polyester fiber of the present embodiment is, relative to the total amount of the liquid crystal polyester fiber, preferably 90 mass % or more, more preferably 95 mass % or more, and further preferably 100 mass %, that is, the liquid crystal polyester fiber consists of the liquid crystal polyester.

The above described liquid crystal polyester fiber of the first embodiment has higher thermal resistance than conventional liquid crystal polyester fibers since it has the maximum value of the crystallite size of 120×10⁻¹⁰ m or larger. This may be because the liquid crystal polyester in the liquid crystal polyester fiber has an high molecular weight and high orientation when the maximum value of the crystallite size is 120×10⁻¹⁰ m or larger.

<Liquid Crystal Polyester Fiber of Second Embodiment>

A liquid crystal polyester fiber of the second embodiment is a fiber comprising the liquid crystal polyester.

A melting point of the liquid crystal polyester fiber of the present embodiment is 360° C. or higher, preferably 370° C. or higher, and more preferably 380° C. or higher.

When the melting point is equal to or higher than the preferable value described above, the liquid crystal polyester fiber of the present embodiment is easily applied for products requiring further thermal resistance, such as a handle heater and protecting clothes.

An upper limit of the melting point of the liquid crystal polyester fiber of the present embodiment is not particularly limited, and preferably, for example, 450° C. or lower.

Regarding the liquid crystal polyester fiber of the present embodiment, a maximum value of a crystallite size determined by [Method for Measuring Crystallite Size] described above is preferably 120×10⁻¹⁰ m or larger, more preferably 125×10⁻¹⁰ m or larger, and further preferably 135×10⁻¹⁰ m or larger.

The maximum value of the crystallite size is typically 350×10⁻¹⁰ m or smaller, preferably 310×10⁻¹⁰ m or smaller, and more preferably 190×10⁻¹⁰ m or smaller.

When the maximum value of the crystallite size of the liquid crystal polyester fiber of the present embodiment is equal to or larger than the preferable lower limit described above, the thermal resistance is further improved by increasing molecular weight and increasing orientation.

Meanwhile, when the maximum value of the crystallite size of the liquid crystal polyester fiber of the present embodiment is equal to or smaller than the upper limit described above, the thermal resistance is easily maintained.

The maximum value of the crystallite size of the liquid crystal polyester fiber of the present embodiment is preferably, for example, 120×10⁻¹⁰ m or larger and 350×10⁻¹⁰ m or smaller, more preferably 125×10⁻¹⁰ m or larger and 310×10⁻¹⁰ m or smaller, and further preferably 135×10⁻¹⁰ m or larger and 190×10⁻¹⁰ m or smaller.

In the liquid crystal polyester fiber of the present embodiment, the melting point and the maximum value of the crystallite size of the liquid crystal polyester fiber can be controlled by, for example, a type and a producing method for the liquid crystal polyester.

In the control by the type of the liquid crystal polyester, a type of repeating unit constituting the liquid crystal polyester, its ratio, or the like is appropriately selected.

<Liquid Crystal Polyester>

The liquid crystal polyester resin of the present embodiment is not particularly limited as long as it is a polyester resin exhibiting a liquid-crystalline property in a melted state. Examples thereof include resins same as the liquid crystal polyester described as the raw material of the liquid crystal polyester fiber of the first embodiment.

The liquid crystal polyester used as the raw material of the liquid crystal polyester fiber has a flow starting temperature of, for example, 280° C. or higher, preferably 280° C. or higher and 400° C. or lower, and more preferably 280° C. or higher and 360° C. or lower. Although a higher flow starting temperature more easily improves the thermal resistance, strength, and rigidity, an exceedingly high flow starting temperature is likely to rise a melting temperature and a melting viscosity, and tends to be difficult fibrillation.

The liquid crystal polyester resin of the present embodiment is preferably the liquid crystal polyester resin A or the liquid crystal polyester resin B, described above. From a viewpoint of further improvement of the strength of the obtained liquid crystal polyester fiber, the resin A is preferable. From a viewpoint of further improvement of elasticity of the obtained liquid crystal polyester, the resin B is preferable.

The liquid crystal polyester fiber of the present embodiment may comprise optional components other than the above liquid crystal polyester without impairing the effect of the present invention. Examples of the optional components include a light resisting agent, carbon black, titanium oxide, a colorant (a pigment and a dye), an antistat, and an antioxidant.

A content of the liquid crystal polyester in the liquid crystal polyester fiber of the present embodiment is, relative to the total amount of the liquid crystal polyester fiber, preferably 90 mass % or more, more preferably 95 mass % or more, and further preferably 100 mass %, that is the liquid crystal polyester fiber consists of the liquid crystal polyester.

The above-described liquid crystal polyester fiber of the second embodiment has higher thermal resistance than conventional liquid crystal polyester fibers since it has the melting point of 360° C. or higher.

(Method for Producing Liquid Crystal Polyester Fiber)

A method for producing the liquid crystal polyester fiber of the present embodiment comprises: a fibrillating step of processing a liquid crystal polyester into a fiber shape by a melt-spinning method; and a heat-treating step of heating, at a temperature of 330° C. or higher, a fibric liquid crystal polyester produced in the fibrillating step.

[Fibrillating Step]

The fibrillating step is a step in which the above-described liquid crystal polyester is processed into a fiber shape by a melt-spinning method. The liquid crystal polyester may be a liquid crystal polyester alone, and may be a liquid crystal polyester composition containing the liquid crystal polyester and, as optional components, a light resisting agent, carbon black, titanium oxide, a colorant (a pigment and a dye), an antistat, and an antioxidant.

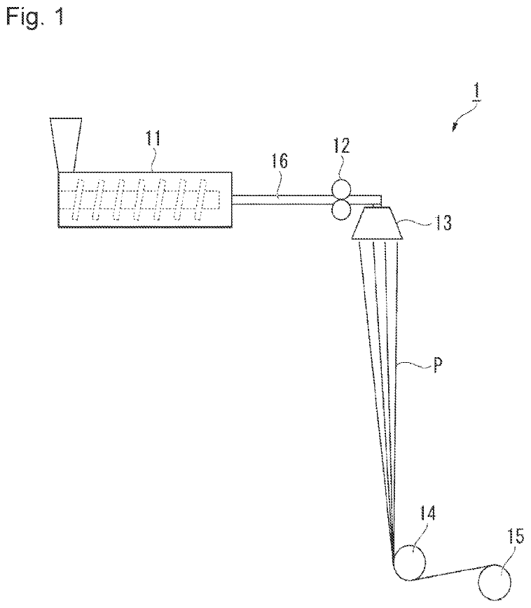

FIG. 1 is a schematic view illustrating an example of a spinning machine used for the method for producing the liquid crystal polyester fiber of the present embodiment.

A spinning machine 1 has an extruder 11, a gear pump 12, a nozzle part 13, a drawing roller 14, a winding part 15, and a resin channel 16.

The spinning machine 1 may have: a filter made of stainless steel or the like and provided in the middle of the resin channel 16; and a supplying apparatus supplying a sizing agent, oil, or the like and provided between the nozzle part 13 and the drawing roller 14.

The extruder 11 and the nozzle part 13 are connected each other through the resin channel 16. The gear pump 12 is provided in the middle of the resin channel 16. The drawing roller 14 is provided downward the nozzle part 13.

The fibrillating step specifically includes: a melting procedure of melting the liquid crystal polyester at a temperature equal to or higher than the flow starting temperature of the liquid crystal polyester; a fibrillating procedure of fibrillating the melted liquid crystal polyester; and a winding procedure of winding the fibrillated liquid crystal polyester.

—Melting Procedure

In the melting procedure, the liquid crystal polyester is heated to a temperature equal to or higher than the flow starting temperature to be melted by using the extruder 11.

The extruder 11 is not particularly limited as long as it can melt the liquid crystal polyester at a temperature equal to or higher than the flow starting temperature. The extruder 11 may be a single-screw extruder, and may be a double-screw extruder.

A melting temperature and melting time of the liquid crystal polyester with the extruder 11 are preferably regulated without decomposing the liquid crystal polyester during the melting.

—Fibrillating Procedure

In the fibrillating procedure, the melted liquid crystal polyester is compressively transferred to the nozzle part 13 with the gear pump 12, and extruded through the nozzle part 13 to obtain a single fiber P of the liquid crystal polyester.

The nozzle part 13 has a plurality of nozzles. A diameter of the nozzle is preferably 0.05 mm or more and 0.20 mm or less, and more preferably 0.07 mm or more and 0.15 mm or less. When the nozzle diameter is 0.20 mm or less, a strong shearing force is likely to be applied to the liquid crystal polyester extruded through the nozzle.

As a result, an orientation degree of the liquid crystal polyester in the liquid crystal polyester fiber is likely to be high. Meanwhile, when the nozzle diameter is 0.05 mm or more, a risk of a stack of the liquid crystal polyester in the nozzle is reduced.

A discharging amount of the liquid crystal polyester through the nozzle part 13 is preferably regulated without occurring a broken thread of the liquid crystal polyester fiber during the melt spinning. The discharging amount of the liquid crystal polyester is, for example, 1 to 40 g/min, and preferably 10 to 30 g/min.

A shear rate at the nozzle part 13 is preferably 10000 s⁻¹ or more and 100000 s⁻¹ or less, and more preferably 30000 s⁻¹ or more and 80000 s⁻¹ or less.

When the shear rate is 10000 s⁻¹ or more, a strong shearing force is likely to be applied to the liquid crystal polyester extruded through the nozzle. As a result, an orientation degree of the liquid crystal polyester in the liquid crystal polyester fiber is likely to be high.

Meanwhile, when the shear rate is 100000 s⁻¹ or less, a risk of occurring a broken thread of the liquid crystal polyester fiber during the melt spinning is reduced.

The number of the pores in the nozzle part 13 is not particularly limited, and is appropriately selected depending on a type of the used melting spinner and a required production amount.

—Winding Procedure

In the winding procedure, a plurality of the single fiber P of the liquid crystal polyester is drawn with the drawing roller 14, and wound to a bobbin made of SUS or the like with the winding part 15 to obtain the fibric liquid crystal polyester constituted with the plurality of the single fiber. This fibric liquid crystal polyester is a fiber of a so-called multifilament.

A winding rate of the fibric liquid crystal polyester in the winding part 15 is preferably 200 m/min or more and 1500 m/min or less, and preferably 400 m/min or more and 1200 m/min or less.

When the winding rate of the fibric liquid crystal polyester is 200 m/min or more, the liquid crystal polyester in the fibric liquid crystal polyester is likely to be elongated in the longitudinal direction. As a result, an orientation degree of the liquid crystal polyester is likely to be high.

Meanwhile, when the winding rate of the fibric liquid crystal polyester is 1500 m/min or less, a risk of breaking the fibric liquid crystal polyester is reduced.

The fibric liquid crystal polyester obtained after the winding step of the present embodiment is referred to as “as-spun fiber”. A strength of this fibric liquid crystal polyester tends to be higher than a strength of an organic fiber comprising a polyester other than the liquid crystal polyester.

[Heat-Treating Step]

The heat-treating step is a step of heating, at a temperature of 330° C. or higher, the fibric liquid crystal polyester produced in the fibrillating step.

Specifically, as the heat-treating step, the fibric liquid crystal polyester wound to the bobbin or the like is heated by using an oven or the like. By doing this step, the molecular weight of the liquid crystal polyester is increased and then a liquid crystal polyester fiber having improved thermal resistance and strength is obtained.

A heat-treatment temperature in the heat-treating step of the present embodiment is 330° C. or higher, preferably 340° C. or higher, more preferably 350° C. or higher, and further preferably 360° C. or higher.

Meanwhile, the heat-treatment temperature in the heat-treating step of the present embodiment is preferably 400° C. or less, and more preferably 380° C. or less.

When the heat-treatment temperature in the heat-treating step is equal to or higher than the above preferable value, the increases of the molecular weight and orientation of the liquid crystal polyester in the liquid crystal polyester fiber easily proceed to further improve the thermal resistance of the manufactured liquid crystal polyester fiber.

When the heat-treatment temperature in the heat-treating step is equal to or lower than the above preferable value, a risk of pyrolyzing the liquid crystal polyester in the liquid crystal polyester fiber is reduced.

The heat-treatment temperature in the heat-treating step is preferably, for example, 330° C. or higher and 400° C. or lower, more preferably 340° C. or higher and 400° C. or lower, further preferably 350° C. or higher and 400° C. or lower, and particularly preferably 360° C. or higher and 380° C. or lower.

The heat-treatment time in the heat-treating step of the present embodiment is preferably 0.5 hours or longer and 50 hours or shorter, and more preferably 1 hour or longer and 20 hours or shorter.

An atmosphere during the heat treatment is preferably an inert gas atmosphere, such as nitrogen and argon, or a vacuum with a vacuum degree of 13.3 kPa (100 mmHg) or less. Note that a dehumidified inert gas is preferable since the liquid crystal polyester tends to be easily hydrolyzed. For example, a dew point of the inert gas is preferably −20° C. or lower, and more preferably −50° C. or lower.

The above-described method for producing the liquid crystal polyester fiber of the present embodiment comprises the heat-treating step of heating the fibric liquid crystal polyester at a temperature of 330° C. or higher. Since the method for producing the liquid crystal polyester fiber of the present embodiment comprises the step of treating the fibric liquid crystal polyester at temperature equal to or higher than the melting point of the liquid crystal polyester which is a raw material, the molecular weight and the orientation of the liquid crystal polyester in the liquid crystal polyester fiber can be increased. Thus, according to the method for producing the liquid crystal polyester fiber of the embodiment, the liquid crystal polyester fiber having improved thermal resistance can be manufactured.

### Other Embodiments

In the heat-treating step, the liquid crystal polyester fiber may be manufactured by passing the fibric liquid crystal polyester discharged through the nozzle part 13 as it is through the heating furnace to heat-treat the fibric liquid crystal polyester. In addition, in the heat-treating step, the fibric liquid crystal polyester may be drawn from the bobbin or the like after the winding step and then the heat-treatment may be performed.

### EXAMPLES

Hereinafter, the present invention will be described more specifically with Examples, but the present invention is not limited to the following Examples.

[Measurement of Flow Starting Temperature of Liquid Crystal Polyester]

A flow starting temperature of a liquid crystal polyester used as a raw material of a liquid crystal polyester fiber was measured by using a flowability characteristics evaluation apparatus (manufactured by SHIMADZU CORPORATION, product name: “Flowtester CFT-500 type”).

A die-attached capillary rheometer having an inner diameter of 1 mm and a length of 10 mm was filled with approximately 2 g of a sample. Specified as the flow starting temperature was a temperature at which the liquid crystal polyester exhibits a melting viscosity of 4800 Pa·s (48000 poises) when extruded through the nozzle under a load of 9.8 MPa (100 kgf/cm²) with heating at a heating rate of 4° C./min. Table 1 shows the results as “Flow starting temperature (° C.)”.

### Production Example 1 of Liquid Crystal Polyester (Production Example of Resin A1)

(1) Melt Polymerization

Into a reactor equipped with a stirring apparatus, a torque meter, a nitrogen gas introduction tube, a thermometer, and a reflux cooler, 1034.99 g (5.5 mol) of 6-hydroxy-2-naphthoic acid, 272.52 g (2.475 mol, excessively charged by 0.225 mol) of hydroquinone, 378.33 g (1.75 mol) of 2,6-naphthalenedicarboxylic acid, 83.07 g (0.5 mol) of terephthalic acid, 1226.87 g (12.0 mol) of acetic anhydride, and 0.17 g of 1-methylimidazole as a catalyst were added. The mixture was stirred at a room temperature over 15 minutes, and then heated with stirring. Once the inner temperature reached 140° C., the mixture was stirred over 1 hour with maintaining 140° C.

Subsequently, the mixture was heated from 140° C. to 310° C. over 3 hours and 30 minutes with removing an acetic acid byproduct and an unreacted acetic anhydride, and maintained at 310° C. for 3 hours. The obtained content was taken out and cooled to a room temperature. The obtained solid product was crushed to a particle diameter of approximately 0.1 to 1 mm with a crushing machine and a prepolymer powder was obtained. The prepolymer had a flow starting temperature of 265° C.

(2) Solid-Phase Polymerization

The prepolymer powder was heated from 25° C. to 250° C. over 1 hour, heated from 250° C. to 285° C. over 7 hours, and further maintained at 285° C. for 5 hours to perform solid-phase polymerization. A powder after the solid-phase polymerization was cooled to obtain a liquid crystal polyester powder. A flow starting temperature of the obtained liquid crystal polyester (resin A1) was measured, and was 310° C.

A ratio of each constituting unit in the resin A1, relative to the total amount of all the repeating units, calculated from the charged amount of the raw material monomer was as follows: a repeating unit (u1) in which Ar¹ was a 2,6-naphthylene group (that is, a repeating unit derived from 6-hydroxy-2-naphthoic acid) was 55 mol %; a repeating unit (u2) in which Ar² was 2,6-naphthylene group (that is, a repeating unit derived from 2,6-naphthalenedicarboxylic acid) was 22.5 mol %; a repeating unit (u2) in which Ar² was a 1,4-phenylene group (that is, a repeating unit derived from terephthalic acid) was 5 mol %; and a repeating unit (u3) in which Ar³ was a 1,4-phenylene group (that is, a repeating unit derived from hydroquinone) was 17.5 mol %.

A ratio of the repeating units having the 2,6-naphthylene group in the resin A1 was 77.5 mol % relative to the total amount of all the repeating units.

### Production Example 2 of Liquid Crystal Polyester (Production Example of Resin B1)

(1) Melt Polymerization

Into a reactor equipped with a stirring apparatus, a torque meter, a nitrogen gas introduction tube, a thermometer, and a reflux cooler, added were 911 g (6.6 mol) of p-hydroxybenzoic acid, 409 g (2.2 mol) of 4,4′-dihydroxybiphenyl, 91 g (0.55 mol) of isophthalic acid, 274 g (1.65 mol) of terephthalic acid, 1235 g (12.1 mol) of acetic anhydride, and the mixture was stirred. Then, into the stirred mixture, 0.17 g of 1-methylimidazole was added, and the inside of the reactor was sufficiently replaced with nitrogen gas. The mixture was then heated to 140° C. over 15 minutes under the nitrogen gas flow, and maintained at a temperature of 140° C. to reflux for 1 hour.

Subsequently, the mixture was heated from 140° C. to 320° C. over 2 hours and 50 minutes with removing an acetic acid byproduct and an unreacted acetic anhydride. A time at which increase in torque was observed was specified as an end of the reaction, and an obtained content was recovered and cooled to a room temperature. An obtained solid product was crushed to a particle diameter of approximately 0.1 to 1 mm with a crushing machine to obtain a prepolymer powder. The prepolymer had a flow starting temperature of 250° C.

(2) Solid-Phase Polymerization

The prepolymer powder was heated from 25° C. to 250° C. over 1 hour, heated from 250° C. to 265° C. over 2.5 hours, and further maintained at 265° C. for 5 hours to perform solid-phase polymerization. A powder after the solid-phase polymerization was cooled to obtain a liquid crystal polyester powder. A flow starting temperature of the obtained liquid crystal polyester (resin B1) was measured, and was 307° C.

A ratio of each constituting unit in the resin B1, relative to the total amount of all the repeating units, calculated from the charged amount of the raw material monomer was as follows: a repeating unit (u4) in which Ar⁴ was a p-phenylene group (that is, a repeating unit derived from p-hydroxybenzoic acid) was 60 mol %; a repeating unit (u5) in which Ar⁵ was p-phenylene group (that is, a repeating unit derived from terephthalic acid) was 15 mol %; a repeating unit (u5) in which Ar⁵ was a m-phenylene group (that is, a repeating unit derived from isophthalic acid) was 5 mol %; and a repeating unit (u6) in which Ar⁶ was a 4,4′-biphenylylene group and X and Y were oxygen atoms (that is, a repeating unit derived from 4,4′-dihydroxybiphenyl) was 20 mol %.

### Example 1

The liquid crystal polyester (resin B1) obtained in Production Example 2 of the liquid crystal polyester was melt-kneaded at 340° C. by using a double-screw extruder (manufactured by Ikegai Corporation; product name “PCM-30”) to be granulate-processed into a pellet. A flow starting temperature of the pellet liquid crystal polyester (pellet resin B1) was measured, and was 300° C.

—Fibrillating Step

Then, the pellet liquid crystal polyester was melted, and the melted liquid crystal polyester was filtered with a filter (made of stainless steel) by using a multifilament spinner (manufactured by Chubu Kagaku Kikai Seisakusho K.K., product name “POLYMERMATE V”), then discharged through a nozzle having 24 pores and a diameter of 0.15 mm under conditions of a spinning temperature of 345° C., a discharging amount of 11 g/min, and a winding rate of 380 m/min. A fiber obtained by the melt spinning was wound to a bored metal bobbin to obtain a fibric liquid crystal polyester.

—Heat-Treating Step

Then, the fibric liquid crystal polyester wound to the bored metal bobbin was treated under a nitrogen atmosphere at a heat-treatment temperature of 360° C. to obtain a liquid crystal polyester fiber of Example 1.

A fiber diameter of the liquid crystal polyester fiber of Example 1, measured with a scanning electron microscope, was 20 μm.

### Example 2

The liquid crystal polyester (resin A1) obtained in Production Example 1 of the liquid crystal polyester was melt-kneaded at 340° C. by using a double-screw extruder (manufactured by Ikegai Corporation; product name “PCM-30”) to be granulate-processed into a pellet. A flow starting temperature of the pellet liquid crystal polyester (pellet resin A1) was measured, and was 303° C.

—Fibrillating Step

Then, the pellet liquid crystal polyester was melted, and the melted liquid crystal polyester was filtered with a filter (made of stainless steel) by using a multifilament spinner (manufactured by Chubu Kagaku Kikai Seisakusho K.K., product name “POLYMERMATE V”), then discharged through a nozzle having 24 pores and a diameter of 0.15 mm under conditions of a spinning temperature of 345° C., a discharging amount of 11 g/min, and a winding rate of 380 m/min. A fiber obtained by the melt spinning was wound to a bored metal bobbin and then a fibric liquid crystal polyester was obtained.

—Heat-Treating Step

Then, the fibric liquid crystal polyester wound to the bored metal bobbin was treated under a nitrogen atmosphere at a heat-treatment temperature of 360° C. to obtain a liquid crystal polyester fiber of Example 2.

A fiber diameter of the liquid crystal polyester fiber of Example 2, measured with a scanning electron microscope, was 20 μm.

### Example 3

A liquid crystal polyester fiber of Example 3 was obtained in the same manner as in Example 1 except that the heat treatment temperature in the heat-treating step was changed from 360° C. to 330° C.

A fiber diameter of the liquid crystal polyester fiber of Example 3, measured with a scanning electron microscope, was 20 μm.

### Example 4

A liquid crystal polyester fiber of Example 4 was obtained in the same manner as in Example 2 except that the heat treatment temperature in the heat-treating step was changed from 360° C. to 330° C.

A fiber diameter of the liquid crystal polyester fiber of Example 4, measured with a scanning electron microscope, was 20 μm.

### Comparative Example 1

The liquid crystal polyester (resin B1) obtained in Production Example 2 of the liquid crystal polyester was melt-kneaded at 340° C. by using a double-screw extruder (manufactured by Ikegai Corporation; product name “PCM-30”) to be granulate-processed into a pellet.

—Fibrillating Step

Then, the pellet liquid crystal polyester was melted, and the melted liquid crystal polyester was filtered with a filter (made of stainless steel) by using a multifilament spinner (manufactured by Chubu Kagaku Kikai Seisakusho K.K., product name “POLYMERMATE V”), then discharged through a nozzle having 24 pores having a diameter of 0.15 mm under conditions of a spinning temperature of 345° C., a discharging amount of 11 g/min, and a winding rate of 380 m/min. A fiber obtained by the melt spinning was wound to a bored metal bobbin to obtain a liquid crystal polyester fiber of Comparative Example 1.

A fiber diameter of the liquid crystal polyester fiber of Comparative Example 1, measured with a scanning electron microscope, was 20 μm.

### Comparative Example 2

The liquid crystal polyester (resin A1) obtained in Production Example 1 of the liquid crystal polyester was melt-kneaded at 340° C. by using a double-screw extruder (manufactured by Ikegai Corporation; product name “PCM-30”) to be granulate-processed into a pellet shape.

—Fibrillating Step

Then, the pellet liquid crystal polyester was melted, and the melted liquid crystal polyester was filtered with a filter (made of stainless steel) by using a multifilament spinner (manufactured by Chubu Kagaku Kikai Seisakusho K.K., product name “POLYMERMATE V”), then discharged through a nozzle having 24 pores and a diameter of 0.15 mm under conditions of a spinning temperature of 345° C., a discharging amount of 11 g/min, and a winding rate of 380 m/min. A fiber obtained by the melt spinning was wound with a bored metal bobbin to obtain a liquid crystal polyester fiber of Comparative Example 2.

A fiber diameter of the liquid crystal polyester fiber of Comparative Example 2, measured with a scanning electron microscope, was 20 μm.

[Measurement of Maximum Value of Crystallite Size of Liquid Crystal Polyester Fiber]

A crystallite size of the liquid crystal polyester fiber of each example was measured according to an X-ray diffraction method by using a beamline of BLO3XU in a large synchrotron radiation facility, SPring-8, (FSBL second hatch, beam size: 1 μm, detector: Pilatus).

Step (1): The liquid crystal polyester fiber of each example, which was a sample, was continuously irradiated with X-ray having a wavelength of 1×10⁻¹⁰ m with intervals of 1 μm (distance: 0 to 18 μm) in the diameter direction of the liquid crystal polyester fiber.

Step (2): The diffraction peak of the 110 plane derived from the liquid crystal polyester was determined.

Step (3): A half-value width (P) of the determined diffraction peak of the 110 plane was determined.

Step (4): A crystallite size was then determined by using the Scherrer equation represented by the following equation (is),

D=K·λ/β cos θ (1s)

wherein D represents a crystallite size, λ represents a wavelength of the measurement X-ray, β represents a half-value width (radian), θ represents a diffraction angle, and K represents a Scherrer constant (0.9).

Step (5): A crystallite size distribution in the diameter direction of the liquid crystal polyester fiber was then calculated, and its maximum value was obtained. Table 1 shows the result as “Maximum value of crystallite size (10⁻¹⁰ m)”.

[Measurement of Melting Point of Liquid Crystal Polyester Fiber]

A melting point of the liquid crystal polyester fiber of each example was measured by using a differential scanning calorimeter (manufactured by SHIMADZU CORPORATION, product name: DSC-50). Specified as the melting point of the liquid crystal polyester fiber was a position at an endothermic peak on the highest temperature side observed with the measurement from a room temperature under a heating condition of 10° C./min. Table 1 shows the results as “Melting Point (° C.)”.

TABLE 1

| | | | | | Comparative | Comparative |
|---|---|---|---|---|---|---|
| | Example 1 | Example 2 | Example 3 | Example 4 | Example 1 | Example 2 |
| Liquid | Resin | Resin | Resin | Resin | Resin | Resin |
| crystal | B1 | A1 | B1 | A1 | B1 | A1 |
| polyester | | | | | | |
| Flow | 300 | 303 | 300 | 303 | 300 | 303 |
| starting | | | | | | |
| temperature | | | | | | |
| (° C.) | | | | | | |
| Heat | 360 | 360 | 330 | 330 | — | — |
| treatment | | | | | | |
| temperature | | | | | | |
| (° C.) | | | | | | |
| Maximum | 140 | 180 | 255 | 300 | 50 | 100 |
| value of | | | | | | |
| crystallite | | | | | | |
| size | | | | | | |
| (10⁻¹⁰ m) | | | | | | |
| Melting | 390 | >400 | 370 | 363 | 312 | 328 |
| point | | | | | | |
| (° C.) | | | | | | |

Table 1 confirmed that the liquid crystal polyester fibers of Examples 1 to 4, which have the maximum value of the crystallite size of the liquid crystal polyester fiber of 120×10⁻¹⁰ m or larger, have higher melting point and have more excellent thermal resistance than the liquid crystal polyester fiber of Comparative Examples 1 and 2, which have the maximum value of the crystallite size of smaller than 120×10⁻¹⁰ m.

Among them, Table 1 confirmed that the liquid crystal polyester fibers of Examples 1 and 2, which have the maximum value of the crystallite size of the liquid crystal polyester fiber of 140×10⁻¹⁰ and 180×10⁻¹⁰ m, have particularly high melting point and more excellent thermal resistance. The liquid crystal polyester fiber of Example 2 has a melting point of higher than 400° C., which is a melting point equal to or higher than the measurement limit.

Preferable Examples of the present invention have been described above, but the present invention is not limited to these Examples. Addition, omission and substitution of a configuration, and other modifications can be made without departing from the object of the present invention. The present invention is not limited to the above description, but limited only to the scope of the attached Claims.

### EXPLANATION OF REFERENCE NUMERALS

1 SPINNING MACHINE
11 EXTRUDER
12 GEAR PUMP
13 NOZZLE PART
14 DRAWING ROLLER
15 WINDING PART
16 RESIN CHANNEL
P SINGLE FIBER OF LIQUID CRYSTAL POLYESTER

1. A liquid crystal polyester fiber comprising a liquid crystal polyester,
wherein a maximum value of a crystallite size determined by the following [Method for Measuring Crystallite Size]method for is 120×10⁻¹⁰ m or larger;
[Method for Measuring Crystallite Size]
A crystallite size of the liquid crystal polyester fiber is obtained by a Scherrer equation represented by the following equation (1s) based on a diffraction peak of a 110 plane of an X-ray diffraction spectrum measured by a wide angle X-ray diffraction method using X-ray having a wavelength of 1×10⁻¹⁰ m,
D=K·λ/β cos θ (1s)
wherein D represents a crystallite size, λ represents a wavelength of the measurement X-ray, β represents a half-value width (radian), θ represents a diffraction angle, and K represents a Scherrer constant (0.9).

2. The liquid crystal polyester fiber according to claim 1, wherein
the liquid crystal polyester has a repeating unit (u1) represented by the following formula (1), a repeating unit (u2) represented by the following formula (2), and a repeating unit (u3) represented by the following formula (3), and
in the repeating units (u1) to (u3), a ratio of a repeating unit having a 2,6-naphthylene group to a total amount of all the repeating units constituting the liquid crystal polyester is 40 mol % or more,
—O—Ar¹—CO— (1)
—CO—Ar²—CO— (2)
—X—Ar³—Y— (3)
wherein Ar¹ represents a phenylene group, a naphthylene group, or a biphenylylene group; Ar² and Ar³ each independently represents a phenylene group, a naphthylene group, or a biphenylylene group; X and Y each independently represents an oxygen atom or an imino group (—NH—); and a hydrogen atom in the group represented by Ar¹, Ar², or Ar³ is each independently optionally substituted by a halogen atom, an alkyl group having 1 to 10 carbon atoms, or an aryl group having 6 to 20 carbon atoms.

3. The liquid crystal polyester fiber according to claim 1, wherein
the liquid crystal polyester has a repeating unit (u4) represented by the following formula (4), a repeating unit (u5) represented by the following formula (5), and a repeating unit (u6) represented by the following formula (6),
—O—Ar⁴—CO— (4)
—CO—Ar⁵—CO— (5)
—X—Ar⁶—Y— (6)
wherein Ar⁴ represents a phenylene group; Ar⁵ and Ar⁶ each independently represents a phenylene group or a biphenylylene group; X and Y each independently represents an oxygen atom or an imino group (—NH—); and a hydrogen atom in the groups represented by Ara, Ar⁵, and Ar⁶ is each independently optionally substituted by a halogen atom, an alkyl group having 1 to 10 carbon atoms, or an aryl group having 6 to 20 carbon atoms.

4. A liquid crystal polyester fiber comprising a liquid crystal polyester; the fiber having a melting point of 360° C. or higher.

5. A method for producing the liquid crystal polyester fiber according to claim 1, the method comprising:
a fibrillating step of processing a liquid crystal polyester into a fiber shape by a melt-spinning method; and
a heat-treating step of heating, at a temperature of 330° C. or higher, a fibric liquid crystal polyester produced in the fibrillating step.
